(19) United States
(12) Patent Application Publication
(10) Pub. No.: US 2015/0052818 A1
(43) Pub. Date: Feb. 26, 2015

(54) DRAFT GUARD

(71) Applicants: Steven Robert Abramson, Victor, NY (US); Gavin Patrick Abramson, Victor, NY (US)

(72) Inventors: Steven Robert Abramson, Victor, NY (US); Gavin Patrick Abramson, Victor, NY (US)

(21) Appl. No.: 14/259,986

(22) Filed: Apr. 23, 2014

Related U.S. Application Data
(63) Continuation of application No. 13/155,382, filed on Jun. 7, 2011, now abandoned.

(51) Int. Cl. E06B 7/16; E06B 7/02; E06B 7/23; E06B 1/70

(52) U.S. Cl. CPC E06B 7/16; E06B 1/70; E06B 7/02; E06B 7/2305
USPC 49/414; 49/475.1; 49/506

(57) ABSTRACT

A draft guard balancer is provided that attaches to, or is otherwise mechanically coupled to, or an integral part of, an existing balance shoe or balancer for a fenestration product such as a double hung window. The draft guard balancer creates a weatherstop along the track of the fenestration product that resists air, water, dirt, dust, pollen, and insects from entering the track and then the building. The draft guard balancer may be used with a balancer having a variety of springs, spring assemblies, balancer shoes and pivot bar arrangements. The draft guard balancer creates a seal that also prevents the increased friction that results from dirt and debris entering the track, thus making for a more energy efficient, easier to operate fenestration product. The draft guard balancer is equally applicable to both top and bottom sashes of a double hung window as well as other fenestration products.

### BACKGROUND OF THE INVENTION

1. Field of the Invention

This application relates generally to window components, and more particularly to a draft guard window balancer system.

2. Description of Related Art

Fenestration products, such as windows and doors, clearly benefit from weather barriers such as weatherstripping as well as sound and tight fitting interrelational parts and components. Such weather barriers serve not only to prevent drafts, but also deter moisture entry as well as insect, dust and pollen infiltration. Over the years, energy efficiency standards as well as an overall awareness of the environmental benefits of energy efficient fenestration products have furthered the demand for proper and improved weather barriers, seals, and fittings. Many improved weatherstripping products now exist to perimeter seal windows and doors. While perimeter weatherstrips are necessary and highly beneficial, there are small openings in windows and doors that, without proper seals, can leak air, water, dust, pollen or even insects into the interior airspace of a building. Often these small openings are due to an interoperable mechanical arrangement that may be difficult to seal off without impacting the mechanical functionality between attendant components. One example of such a situation is that of the ever popular double hung window. A double hung window commonly has two sashes that travel vertically in a tracked frame. A spring assembly is often utilized to facilitate ease of vertical travel of each sash. Oftentimes, a pivot bar inserts into a balancer shoe which connects to a spring assembly to allow a sash to tilt out for cleaning. The use of a tracked frame and a traveling sash setup, while practical, creates a break in the weather barrier of the window that allows air, dust, pollen, moisture, or even insects, to travel up the track and into the building. In a strong wind, the track may even create a chimney effect where cold outside air is forced up the track and into the building through the meeting rail and sill areas. Since the sashes and related components move in the track, it has been difficult to properly weather seal this area of a double hung window. It is therefore an object of the present invention to provide a draft guard that seals the track of a double hung window from environmental factors. It is another object of the present invention to provide a draft guard that travels with a moveable window sash in a double hung window. It is another object of the present invention to provide a draft guard that works in conjunction with a pivoting sash arrangement for a double hung window. It is yet another object of the present invention to provide a draft guard that does not interfere with normal usage movement of a sash in a double hung window. It is a further object of the present invention to provide a window balancer with a draft guard. It is yet another object of the present invention to provide a method of manufacturing a double hung window.

These and other objects of the present invention will be further brought to light upon reading this specification and claims and viewing the attached drawings.

### BRIEF SUMMARY OF THE INVENTION

In accordance with the present invention, there is provided a draft guard for a window balancer comprising a vertical component having a first edge, a second edge, a third edge and a fourth edge; a horizontal component having a first edge, a second edge, a third edge and a fourth edge; the second edge of the horizontal component being joined to the second edge of the vertical component at a generally right angle; the horizontal component further having a first cut and a second cut in proximity to and generally parallel to the second edge; and the vertical component having a pivot bar hole.

The foregoing paragraph has been provided by way of introduction, and is not intended to limit the scope of the invention as described by this specification, claims, and the attached drawings.

### BRIEF DESCRIPTION OF THE DRAWINGS

The invention will be described by reference to the following drawings, in which like numerals refer to like elements, and in which:

FIG. 1 is a plan view of a double hung window with cut line A-A;

FIG. 2 is a cutaway view of the double hung window taken along cut line A-A of FIG. 1;

FIG. 3 is a front plan view of a balancer showing the draft guard in use;

FIG. 4 is a perspective view of a balancer showing the draft guard in use;

FIG. 5 is a right side view of a balancer showing the draft guard in use;

FIG. 6 is a rear plan view of a balancer showing the draft guard in use;

FIG. 7 is a top plan view of a balancer showing the draft guard in use;

FIG. 8 is a bottom plan view of a balancer showing the draft guard in use;

FIG. 9 is a top plan view of the draft guard;

FIG. 10 is a left side view of the draft guard;

FIG. 11 is a front plan view of the draft guard;

FIG. 12 is a right side view of the draft guard;

FIG. 13 is a bottom plan view of the draft guard;

FIG. 14 is a perspective view of the draft guard;

FIG. 15 is a rear plan view of the draft guard;

FIG. 16 is a flattened plan view of the draft guard;

FIG. 17 is a plan view of the sash side of the balancer shoe;

FIG. 18 is a bottom plan view of the sash side of the balancer shoe;

FIG. 19 is a left side view of the sash side of the balancer shoe; and

FIG. 20 is a right side view of the sash side of the balancer shoe;

The present invention will be described in connection with several preferred embodiments; however, it will be understood that there is no intent to limit the invention to the embodiments described. On the contrary, the intent is to cover all alternatives, modifications, and equivalents as may be included within the spirit and scope of the invention as defined by this specification, claims, and the attached drawings.

### DESCRIPTION OF THE PREFERRED EMBODIMENTS

Balances or balancers, as used herein, describe the mechanical component or components that contain a spring or balance assembly that connects a window sash to a master frame to allow for ease of operation. While such balances or balancers are commonly used with double hung windows, other window arrangements may benefit from such hardware such as, for example, sliding windows. Windows may be wood, vinyl, aluminum, fiberglass, or the like. A window balancer configuration allows a window sash to be tilted in a plane outside its normal operating plane to allow for cleaning.

The present invention solves the problem of a draft or chimney effect originating from the hollow chamber tracks in a window frame and the space between a sash and master frame, by adding a draft guard component to a balance or balancer. The draft guard mechanically attaches to a constant force balancer and the balancer pivot bar at the balancer shoe of a block and tackle balancer or a spiral balancer. The present invention includes not only the draft guard, but a balance or balancer having a draft guard, along with a method of manufacturing fenestration products that have a draft guard. In addition, the present invention includes modifications, variations, additions, improvements and enhancements to the present invention that will be known or contemplated after reading this specification and the accompanying drawings.

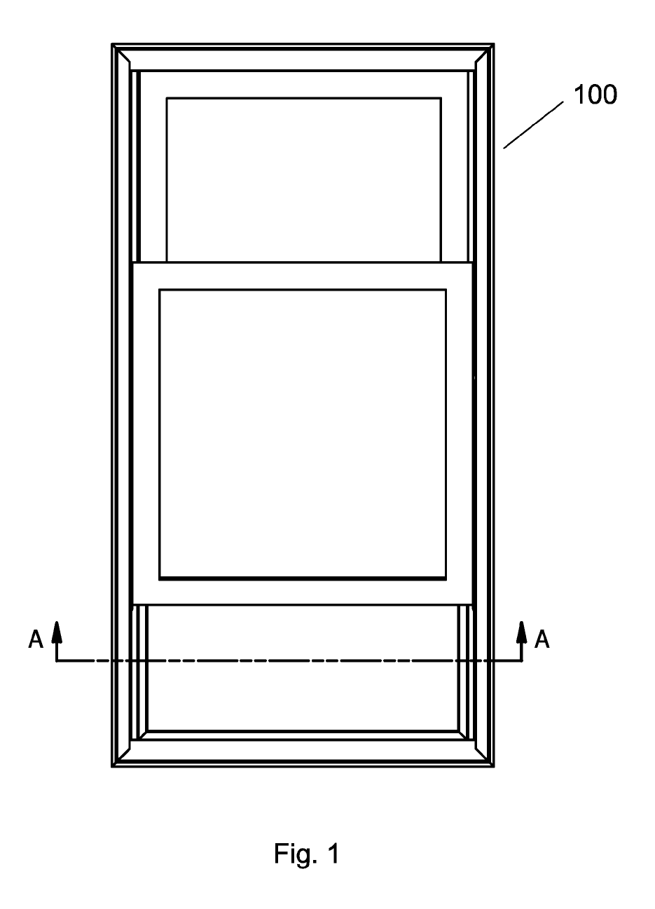

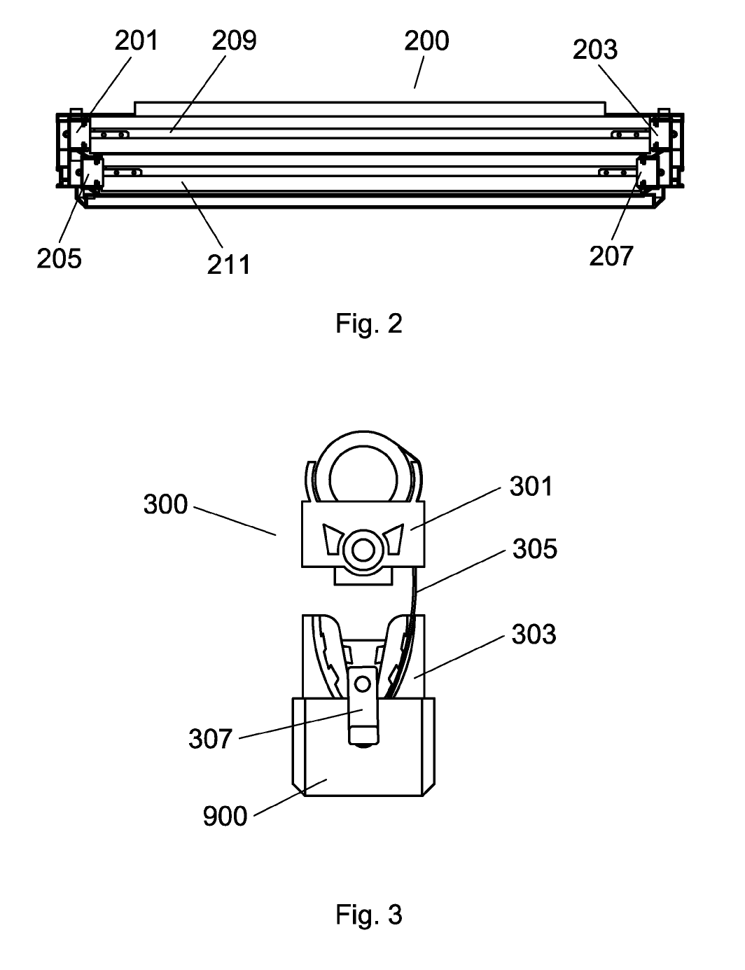

For a better understanding of the present invention and the various embodiments described and envisioned herein, a double hung window is depicted in FIGS. 1 and 2. While arguably the most common application of the present invention, applicability is not limited to double hung windows, but the present invention may find suitable and useful applications in other fenestration products as well.

FIG. 1 is a plan view of a double hung window 100 with cut line A-A. Two window sashes can be seen contained by a tracked frame. The tracks are contained in the frame and make contact with the two vertical edges of each window sash. It is within these tracks that a balancer, spring and draft guard are contained. This arrangement can be better seen in FIG. 2, which is a cutaway view 200 of the double hung window taken along cut line A-A of FIG. 1. The window extrusion chamber hollows can be clearly seen in this cutaway view. A first sash 209 and a second sash 211 can be seen in FIG. 2. In addition, four draft guards can be seen, two per sash. A first draft guard 201 and a second draft guard 203 can be seen at either end of the first sash 209. In a similar arrangement, a third draft guard 205 and a fourth draft guard 207 can also be seen at either end of the second sash 211. The draft guards visible in FIG. 2 are attached to the bottom of a balancer arrangement that is also in use, but cannot be clearly seen in FIG. 2. The balancer arrangement provides mechanical connectivity between the moveable sash and the fixed master frame, with a spring or balance assembly there between for ease of operation. The details of such an arrangement will be further described by way of the remaining figures.

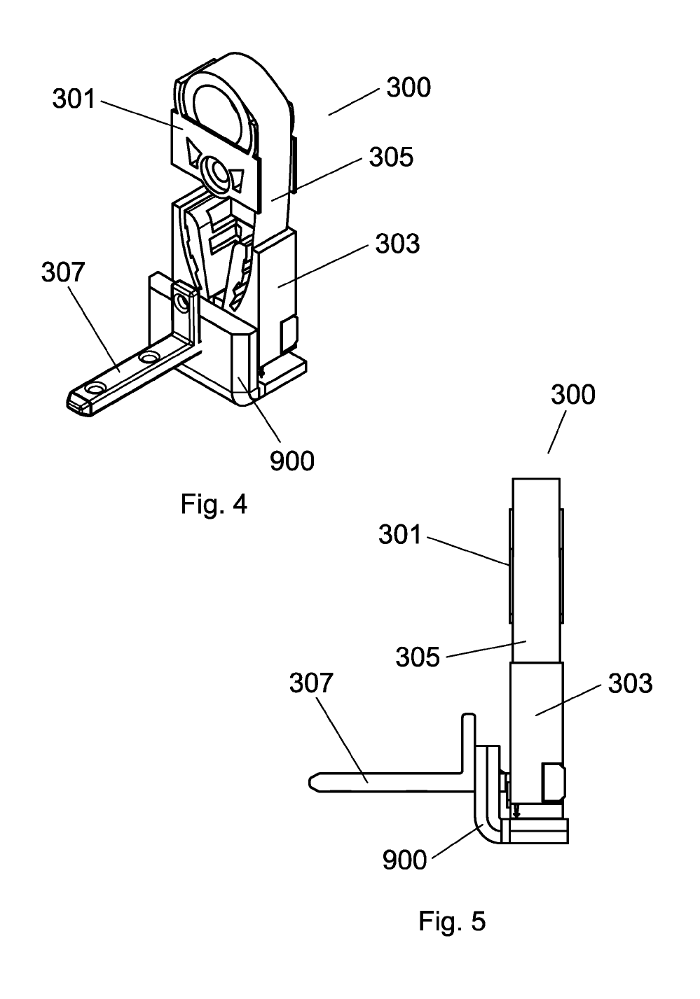

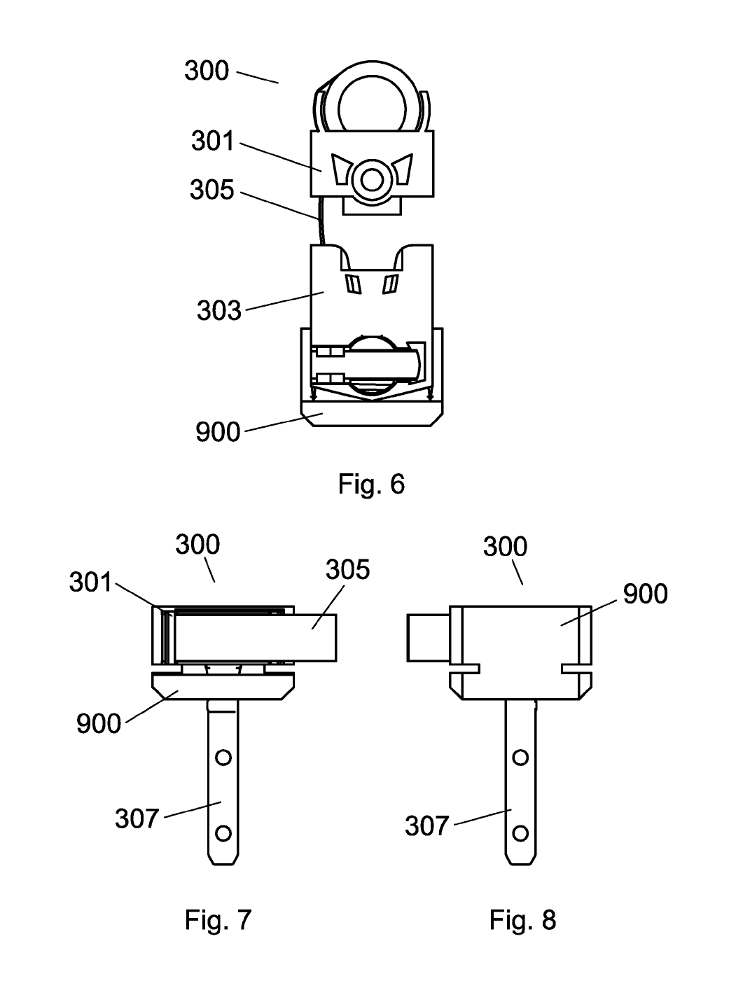

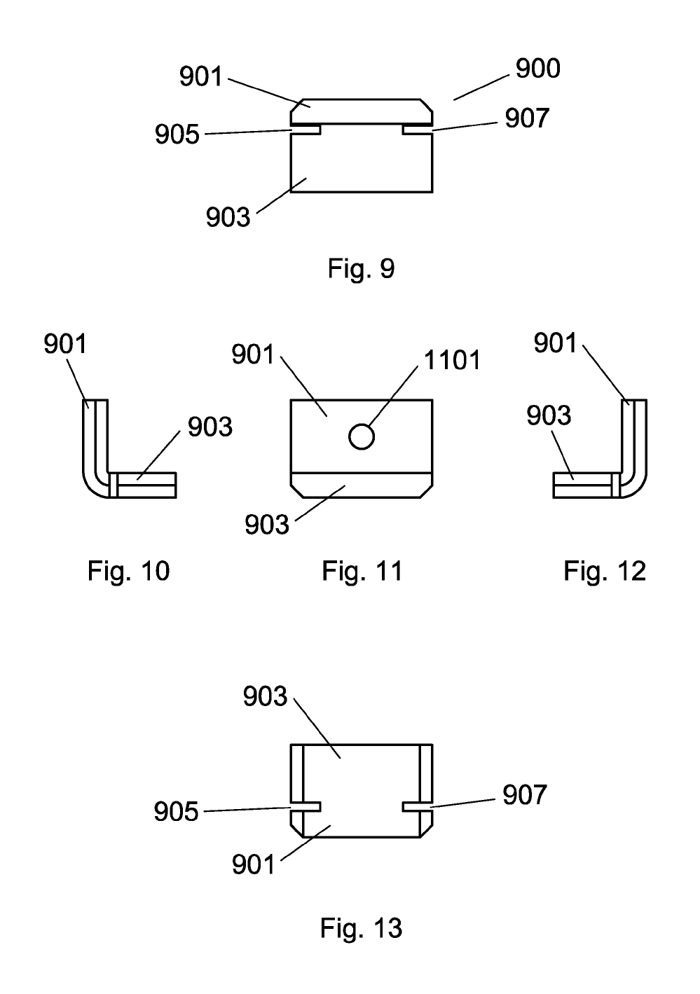

FIGS. 3-8 depict a balancer system showing the draft guard in use. FIG. 3 is a front plan view of a balancer and pivot bar 300 showing the draft guard in use. The upper structure in FIG. 3 is the frame side of the balancer 301 and the lower structure in FIG. 3 is the sash side of the balancer 303. The pivot bar 307 inserts into the shoe of the sash side of the balancer 303. The frame side of the balancer 301 and the sash side of the balancer 303 may be made from a plastic such as polypropylene, nylon or the like, or from a metal such as aluminum. Preferentially, a material with a low coefficient of friction should be used to provide smooth operation. Various plastics fall into this category. The frame side of the balancer 301 and the sash side of the balancer 303 may be injection molded, or machined, for example. Between the frame side of the balancer 301 and the sash side of the balancer 303 is a spring 305. The spring 305 may be a constant force spring made from, for example, flat stock and wound steel or stainless steel. The spring may also be a spiral spring or a block and tackle spring assembly, and may contain a separate balancer shoe not directly attached to a spring housing. Further depicted in FIG. 2 is a pivot bar 307. The pivot bar 307 can be better seen in FIG. 4. The pivot bar 307 is typically made from a metal such as steel, and may be coated, painted or galvanized for rust prevention. The pivot bar 307 is cast, machined or stamped and retains the bottom edge of a window sash connecting directly to a balancer shoe. The figures depict a three hole arrangement for placing screws through the pivot bar 307. Other configurations, such as two holes, one hole, four holes, and the like, and other fasteners may, in some embodiments of the present invention, be used. The pivot bar 307 may, in some embodiments of the present invention, pivot to allow the attached window sash to tilt for cleaning. In some embodiments, the pivot bar engages with a balancer shoe cam that in turn pushes a tab outward to create friction against the track that the balancer shoe rides in, thus allowing the window sash to be tilted for cleaning while maintaining a fixed position in the track. Connected to the balancer and pivot bar is a draft guard 900. FIGS. 9-16 will depict the draft guard removed from the balancer and pivot bar. The draft guard 900 is attached to the pivot bar and attaches to the balancer with an adhesive, a barbed fastener, a rivet, a snap, a mechanical connecting guide, a hook and loop fastener, or the like. Mechanical coupling of the draft guard 900 is to the sash side of the balancer. The placement of the draft guard 900, in use, prevents air, water, dirt, pollen, or insect infiltration up the track and into the building. In addition, the draft guard 900 prevents dirt and debris from entering the track and creating unnecessary friction. In use, the draft guard 900 is bent along and makes contact with surfaces of the window assembly to provide enhanced and improved sealing. A full complement of views of the balancer 300 and draft guard 900 is conveyed by way of FIGS. 4-8. FIG. 4 is a perspective view of a balancer and pivot bar 300 showing the draft guard 900 in use. FIG. 5 is a right side view of a balancer 300 showing the draft guard 900 in use. FIG. 6 is a rear plan view of a balancer 300 showing the draft guard 900 in use. FIG. 7 is a top plan view of a balancer 300 showing the draft guard 900 in use. FIG. 8 is a bottom plan view of a balancer 300 showing the draft guard 900 in use and also showing the pivot bar in place.

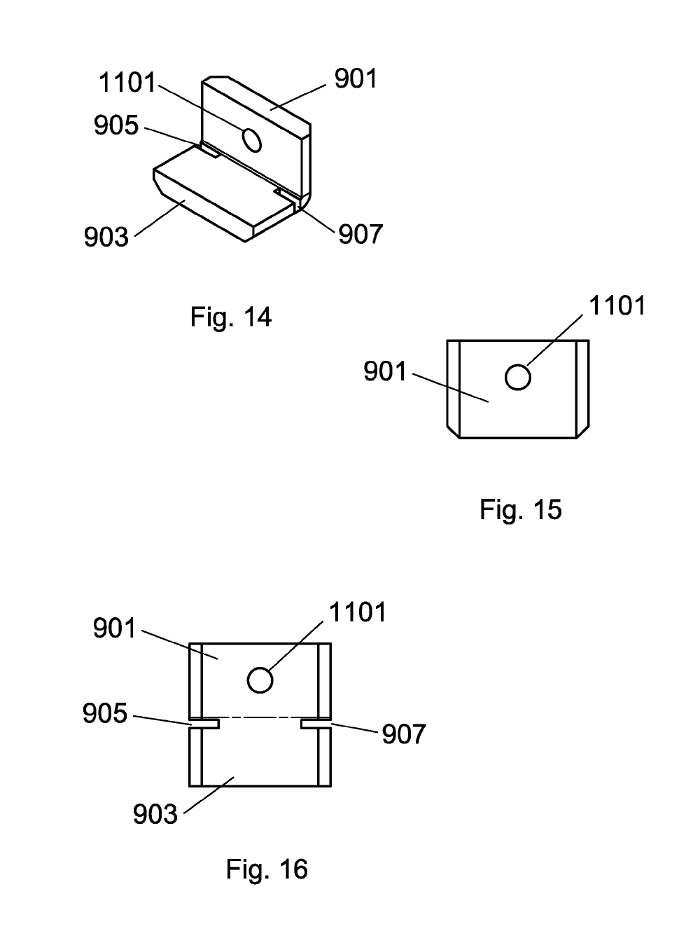

FIGS. 9-16 depict the draft guard 900 removed from the balancer. The draft guard 900 is made from a weatherstopping material such as, for example, ethylene propylene diene monomer (EPDM) rubber, and extruded, die cut, or the like. Other materials that may be used to make the draft guard 900 are thermoplastic elastomers (TPE) that may be extruded, injection molded, die cut, or the like. Another material that may be used to make the draft guard 900 is thermoplastic polyolefin (TPO) and may be processed by injection molding, extruded, thermoformed, die cut, or the like. Other examples of materials that may be used to make the draft guard 900 include polystyrene, foam rubber, silicone, closed cell foam, felt, and the like. Materials used to make the draft guard 900 may also, in some embodiments of the present invention, be treated with an antimicrobial chemical to reduce mold, mildew and degradation related to other organism. An example of such treatment is disclosed in U.S. Pat. No. 5,681,637 to Kessler and Abramson and entitled Microorganism Resistant Pile Weatherstripping, the entire disclosure of which is incorporated herein by reference. FIG. 9 is a top plan view of the draft guard 900. The draft guard 900 comprises a vertical component and a horizontal component. The vertical component 901 has a generally rectangular shape and has a first edge, a second edge, a third edge and a fourth edge. The vertical component 901 can be more clearly seen in FIG. 14. The vertical component 901 has a pivot bar hole 1101 that can be seen in FIG. 14 to accommodate the pivot bar which in turn attaches to the balancer shoe area of a balancer. (not shown in FIG. 9, see FIG. 4). The vertical component 901 is joined to horizontal component 903 at a generally right angle. The horizontal component 903 has a generally rectangular shape and has a first edge, a second edge, a third edge and a fourth edge. The horizontal component 903 further has a first cut 905 and a second cut 907 in proximity to and generally parallel to the second edge. Various embodiments of the draft guard of the present invention may have varying cuts, thicknesses, shapes, and materials that are based, for example, on specifications of the window. In some embodiments the vertical component 901 and the horizontal component 903 are made from a single material and may be formed as one part. Processes to allow the horizontal component 903 and the vertical component 901 to be formed as one part include, but are not limited, to, injection molding, extruding, and the like. FIG. 10 is a left side view of the draft guard 900. FIG. 11 is a front plan view of the draft guard 900. The pivot bar hole 1101 can be clearly seen. The pivot bar hole 1101 accommodates the pivot bar of the balancer shoe (not shown in FIG. 11, see FIG. 4). In some embodiments, the pivot bar hole 1101 may be round, oval, square, rectangular, octagonal, or of another geometry that allows a pivot bar to pass freely. FIG. 12 is a right side view of the draft guard 900. FIG. 13 is a bottom plan view of the draft guard 900. In some embodiments of the present invention, the first and third edges of the horizontal component are beveled. As well, the first and third edges of the vertical component may also be beveled. The bevel may be a 45 degree bevel, or may be of some other angle, or may be a roundover with any radius useful in reducing the sharp angle of the edge and thus provide ease of operation and reduced friction in use. FIG. 14 is a perspective view of the draft guard 900 that clearly shows the orientation of the vertical and horizontal components and the attributes associated with each. FIG. 15 is a rear plan view of the draft guard 900. FIG. 16 is a flattened plan view of the draft guard that clearly shows both the horizontal and the vertical component. A dotted line indicates the fold line of the draft guard. In some embodiments of the present invention, the draft guard may be flat as shown in FIG. 16 prior to assembly and attachment to a pivot bar and balancer. In other embodiments of the present invention, the balancer may be molded or otherwise fabricated with a generally right angle already intrinsic in the draft guard, as shown, for example, in FIG. 14.

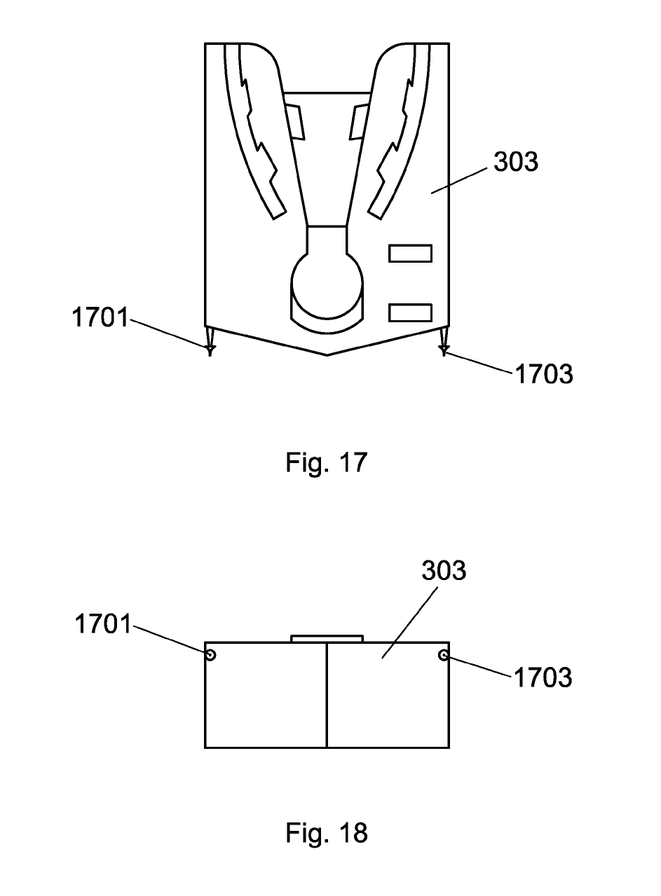

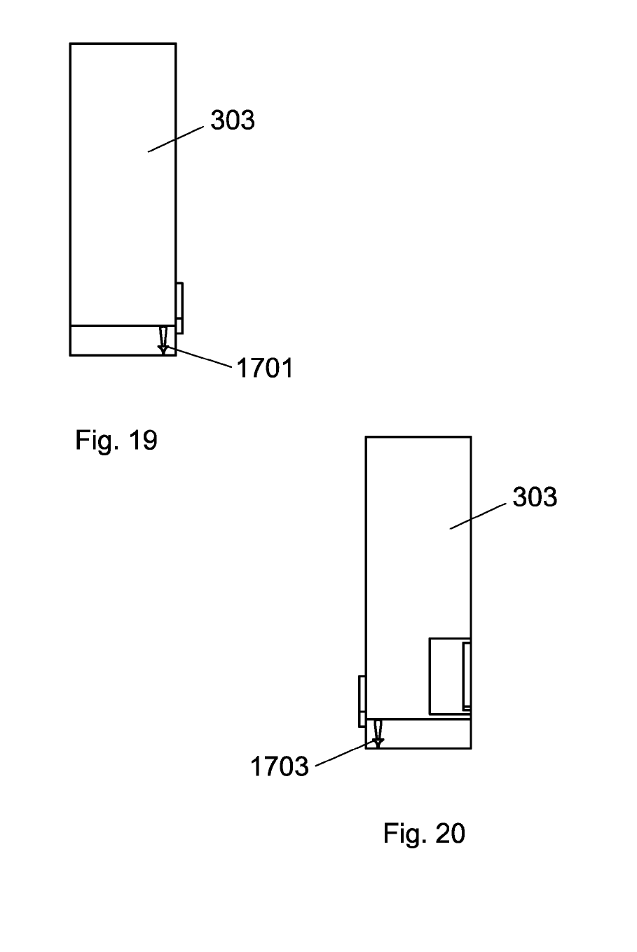

Lastly, FIGS. 17-20 depict a constant force balancer with an exemplary mechanical coupling arrangement for coupling the draft guard (not shown in FIGS. 17-20, see previous figures) to the sash side of the balancer. The example in FIGS. 17-20 is not to be considered limiting. Adhesives, rivets, snaps, mechanical connecting guides, hook and loop fasteners, and other devices and techniques may be used alone or in combination to attach the draft guard to the balancer. FIG. 17 is a plan view of the sash side of the constant force balancer 300 showing an example of the use of a first fastener 1701 and a second fastener 1703 to retain the draft guard to the balancer. The first fastener 1701 and the second fastener 1703 are barbs that may be molded into the sash side of the balancer 303 or may be metal barbs that are inserted into the sash side of the balancer 303 as a secondary operation. These barbs are also shown in FIG. 18 as a bottom plan view of the sash side of the balancer. FIG. 19 is a left side view of the sash side of the balancer and FIG. 20 is a right side view of the sash side of the balancer. Each of FIGS. 17-20 depicts an example of a mechanical coupling fastening technique. Other techniques may be used alone or in combination. The draft guard will, however, be fastened securely to the sash side of the balancer and pivot bar.

The draft guard is used in a fenestration product such as a double hung window. It may be incorporated into the fenestration product during manufacture and assembly, or may, in some embodiments of the present invention, be added to an existing fenestration product either by fastening the draft guard to an existing balancer or balancer shoe, or replacing the balancer with a new balancer or new balancer shoe having a draft guard. To manufacture a double hung window using the present invention, a sash side of the balancer and pivot bar having a draft guard is attached to a first sash, a frame side of a balancer is attached to a double hung window frame, the first sash is installed in the double hung window frame, and a spring is connected between the sash side of the balancer having a draft guard and the frame side of the balancer. Modifications and variations to this manufacturing process may also be contemplated after reading this specification and viewing the attached drawings.

It is, therefore, apparent that there has been provided, in accordance with the various objects of the present invention, a draft guard for a balancer. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the present invention as defined by this specification, claims and the attached drawings.

What is claimed is:

1. A draft guard for a window balancer comprising:
a vertical component having a generally rectangular shape and having a first edge, a second edge, a third edge and a fourth edge;
a horizontal component having a generally rectangular shape and having a first edge, a second edge, a third edge and a fourth edge;
the second edge of the horizontal component being joined to the second edge of the vertical component at a generally right angle;
the horizontal component further having a first cut and a second cut in proximity to and generally parallel to the second edge; and
the vertical component having a pivot bar hole.

2. The draft guard of claim 1, wherein the vertical component and the horizontal component are comprised of a single material.

3. The draft guard of claim 1, wherein said vertical component and said horizontal component are made from a closed cell foam.

4. The draft guard of claim 1, wherein said vertical component and said horizontal component are made from a felt.

5. The draft guard of claim 1, wherein said vertical component and said horizontal component are made from a polypropylene non-woven fabric.

6. The draft guard of claim 1, wherein said vertical component and said horizontal component are made from a foam rubber.

7. The draft guard of claim 1, wherein said vertical component and said horizontal component are made from a silicone.

8. The draft guard of claim 1 wherein the first edge and the third edge of the horizontal component are beveled.

9. The draft guard of claim 1 wherein the first edge and the third edge of the vertical component are beveled.

10. A window balancer comprising:
a frame side component;
a sash side component;
a spring connecting the frame side component to the sash side component; and
a draft guard mechanically coupled to the sash side component.

11. The balancer of claim 10, wherein the spring is a constant force spring.

12. The balancer of claim 10, wherein the spring is a spiral spring.

13. The balancer of claim 10, wherein the window balancer is a block and tackle assembly.

14. The balancer of claim 10, wherein the draft guard is mechanically coupled to the sash side component with an adhesive.

15. The balancer of claim 10, wherein the draft guard is mechanically coupled to the sash side component with a barb.

16. The balancer of claim 10, wherein the draft guard is mechanically coupled to the sash side component with a hook and loop fastener.

17. The balancer of claim 10, wherein the draft guard is mechanically coupled to the sash side component with a mechanical connecting guide.

18. The balancer of claim 10, wherein the draft guard is mechanically coupled to the sash side component with a rivet.

19. The balancer of claim 10, wherein the draft guard is mechanically coupled to the sash side component with a snap.

20. A method of manufacturing a double hung window comprising the steps of:
attaching a sash side of a balancer having a draft guard to a first sash;
attaching a frame side of a balancer to a double hung window frame;
installing the first sash in the double hung window frame; and
connecting a spring between the sash side of the balancer having a draft guard and the frame side of the balancer.
